(19) United States
(12) Patent Application Publication
(10) Pub. No.: US 2011/0273494 A1
(43) Pub. Date: Nov. 10, 2011

(54) FLAT PANEL DISPLAY DEVICE AND METHOD OF DRIVING THE SAME

(76) Inventor: Byung Geun Jun, Yongin-city (KR)

(21) Appl. No.: 13/086,324

(22) Filed: Apr. 13, 2011

(30) Foreign Application Priority Data
May 7, 2010 (KR) 10-2010-0043057

(51) Int. Cl. G09G 5/02

(52) U.S. Cl. 345/694

(57) ABSTRACT

A pentile-type flat panel display device, and a method of driving the same. The flat panel display device includes a scan driving unit to apply a scan signal through a plurality of scan lines; a data driving unit to apply a data signal through a plurality of data lines; and a pixel unit comprising a first pixel column comprising first pixels to display a first color and second pixels to display a second color alternatively aligned in a direction parallel to the data lines, a second pixel column comprising the first pixels and the second pixels alternatively aligned in the direction parallel to the data lines in an order opposite to the order of the first pixels and the second pixels of the first pixel column, and a third pixel column comprising third pixels to display a third color in the direction parallel to the data lines, wherein the data driving unit includes a gamma correction unit, and when a pattern of an input image with an increased number of bits corresponds to a reference image pattern, the gamma correction unit applies a predetermined compensation value to the input image, performs a sub pixel rendering process on the input image, and reduces a number of bits of the rendered image and outputs the rendered image with the decreased number of bits to the pixel unit.

### CROSS-REFERENCE TO RELATED APPLICATION

This application claims the benefit of Korean Application No. 10-2010-0043057, filed on May 7, 2010, in the Korean Intellectual Property Office, the disclosure of which is incorporated herein by reference.

### BACKGROUND

1. Field

One or more embodiments of the present invention relate to a pentile-type flat panel display device and a method of driving the same.

2. Description of the Related Art

Flat panel display devices are used instead of cathode-ray tube display devices because they are lightweight and thin. Examples of flat panel display devices include liquid crystal displays, field emission displays, plasma display panels, and organic light emitting displays.

Organic light emitting displays generate light with a particular wavelength when an exciton formed by a recombination of electrons and holes respectively injected to an organic thin film through a cathode and an anode emits energy. Organic light emitting displays have better luminance characteristics and viewing angle characteristics than liquid crystal displays. In addition, organic light emitting displays do not require a back light, and thus, can be manufactured to have a super thin structure.

In order to embody a full-color image, flat panel display devices include a plurality of red, green, and blue pixels. If the red, green, and blue pixels of a flat panel display device 140 are arranged in a stripe type as illustrated in FIG. 1, each pixel is visually recognized as if it is surrounded by a black matrix. Due to such visual recognition, image data is subjected to rendering.

In general, rendering refers to a process for providing a sense of reality in consideration of surrounding information such as a light source, a location, or a color, that is, rendering is to enhance a three-dimensional effect and a sense of reality by providing shadow to or changing gradation of a two-dimensionally viewed subject. In other word, the rendering is an image process method for displaying two- or three-dimensional graphic image. In order to render image data of a flat panel display device 150, as illustrated in FIG. 1, the flat panel display device 150 includes a plurality of pixels arranged in a pentile type, including a first pixel column including first pixels for displaying a first color and second pixels for displaying a second color which are alternatively aligned in a direction parallel to a plurality of data lines to which data signals are applied, a second pixel column including the first and second pixels alternatively aligned in the direction parallel to the data lines in the opposite order to the order of the first and second pixels of the first pixel column, and a third pixel column including third pixels for displaying a third color aligned in the direction parallel to the data lines.

### SUMMARY

One or more embodiments of the present invention include a flat panel display device capable of reducing a memory used by changing a gamma correction method and a method of driving the same.

According to one or more embodiments of the present invention, a flat panel display device includes a scan driving unit to apply scan signals through a plurality of scan lines; a data driving unit to apply data signals through a plurality of data lines; and a pixel unit including a first pixel column including first pixels to display a first color and second pixels to display a second color alternatively aligned in a direction parallel to the data lines, a second pixel column including the first pixels and the second pixels alternatively aligned in the direction parallel to the data lines in an order opposite to the order of the first pixels and the second pixels of the first pixel column, and a third pixel column including third pixels to display a third color in the direction parallel to the data lines, wherein the data driving unit includes a gamma correction unit, and when a pattern of an input image with an increased number of bits corresponds to a reference image pattern, the gamma correction unit applies a predetermined compensation value to the input image, performs a sub pixel rendering process on the resultant input image, and reduces the number of bits of the rendered image and outputs the rendered image with the decreased number of bits to the pixel unit.

When the pattern of the input image with an increased number of bits does not correspond to the reference image pattern, the gamma correction unit performs a sub pixel rendering process on the input image.

The gamma correction unit may include: a comparison unit to compare the pattern of the input image with the reference image pattern; a bit-number increase unit to increase the number of bits of the input image; a sub pixel rendering unit to apply the predetermined compensation value to the input image with the increased number of bits when the pattern of the input image corresponds to the pattern of a reference image, or to perform a sub pixel rendering on the input image with the increased number of bits when the pattern of the input image does not correspond to the pattern of the reference image; and a bit-number decrease unit to decrease the number of bits of the image that has been subjected to the sub pixel rendering process.

The flat panel display device may further include a storage unit including the reference image pattern for the input image, a reference image pattern for an output image, and the compensation value that is used when the sub pixel rendering process is performed.

The bit-number increase unit may include: a first bit-number increase unit for increasing the numbers of bits of the first pixels of the input image; a second bit-number increase unit for increasing the numbers of bits of the second pixels of the input image; and a third bit-number increase unit for increasing the numbers of bits of the third pixels of the input image.

The bit-number decrease unit may include: a first bit-number decrease unit for decreasing the numbers of bits of the first pixels of the image that have been subjected to the sub pixel rendering process; a second bit-number decrease unit for decreasing the numbers of bits of the second pixels of the image that have been subjected to the sub pixel rendering process; and a third bit-number decrease unit for decreasing the numbers of bits of the third pixels of the image that have been subjected to the sub pixel rendering process.

The flat panel display device may further include an emission control driving unit for controlling emissions of the first pixels, the second pixels, and the third pixels.

The third pixels are any one of red pixels, green pixels, and blue pixels, and each of the first pixels and second pixels is different from the third pixels and any one of red pixels, green pixels, and blue pixels

According to one or more embodiments of the present invention, a method of driving a flat panel display device includes a scan driving unit for applying scan signals through a plurality of scan lines; a data driving unit for applying data signals through a plurality of data lines; and a pixel unit including a first pixel column including first pixels for displaying a first color and second pixels for displaying a second color alternatively aligned in a direction parallel to the data lines, a second pixel column including the first pixels and the second pixels alternatively aligned in the direction parallel to the data lines in an order opposite to the order of the first pixels and the second pixels of the first pixel column, and a third pixel column including third pixels for displaying a third color in the direction parallel to the data lines, the method including: comparing a first, second, and third pixel pattern of an input image with a first, second, and third pixel reference pattern; increasing the numbers of bits of the first, second, and third pixels of the first, second, and third pixel pattern of the input image; if the input first, second, and third pixel pattern corresponds to the first, second, and third pixel reference pattern, performing a sub pixel rendering process by applying a predetermined compensation value to the first, second, and third pixels that have the increased numbers of bits; and decreasing the numbers of bits of the first, second, and third pixels that have been subjected to the sub pixel rendering and outputting an image corresponding to the first, second, and third pixels with a decreased numbers of bits.

If the input first, second, and third pixel pattern does not correspond to the first, second, and third pixel reference pattern, the sub pixel rendering process is performed on the input image.

The increasing of the numbers of bits includes: increasing the numbers of bits of the first pixels of the input image; increasing the numbers of bits of the second pixels of the input image; and increasing the numbers of bits of the third pixels of the input image.

The decreasing of the numbers of bits includes decreasing the numbers of bits of the first pixels of the image that have been subjected to the sub pixel rendering; decreasing the numbers of bits of the second pixels of the image that have been subjected to the sub pixel rendering; and decreasing the numbers of bits of the third pixel of the image that have been subjected to the sub pixel rendering.

The method may further include applying emission control signals for controlling emissions of the first pixels, the second pixels, and the third pixels.

The third pixels may be any one of red pixels, green pixels, and blue pixels, and each of the first pixels and second pixels are different from the third pixels and is any one of red pixels, green pixels, and blue pixels.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a view to explain an arrangement structure of pixels displayed in a panel;

FIG. 2 is a view of the structure of an organic light emitting display according to an embodiment of the present invention;

FIG. 3 is a detailed view of a data driving unit outputting gamma correction signals illustrated in FIG. 2, according to an embodiment of the present invention;

FIG. 4 shows a gamma curve for gamma correction of the data driving unit of FIG. 3;

FIG. 5 is a detailed view of a data driving unit outputting gamma correction signals illustrated in FIG. 2, according to another embodiment of the present invention;

FIG. 6 is a detailed view of a data driving unit outputting gamma correction signals illustrated in FIG. 2, according to another embodiment of the present invention;

FIGS. 7A and 7B are views illustrating reference blocks for an input image and an output image stored in a storage device illustrated in FIG. 6; and

FIG. 8 is a flowchart illustrating a method of driving an organic light emitting display that outputs gamma correction signals, according to an embodiment of the present invention.

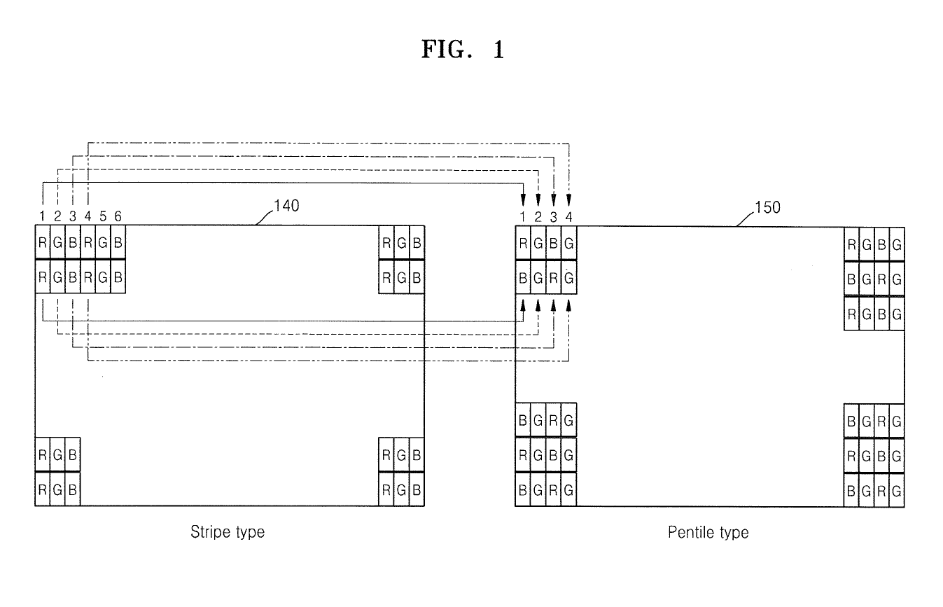

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Hereinafter, embodiments of the present invention will be described with reference to the attached drawings. The following description and the attached drawings are to be used to understand operations according to the present invention, and what those of ordinary skill in the art may easily embody may not be described herein.

The present specification and drawings are not provided to limit the present invention and the scope of the present invention should be determined according to claims. The terms used in the present specification should be understood with the meaning and concept which satisfy technical contents of the present invention in order to appropriately express the present invention.

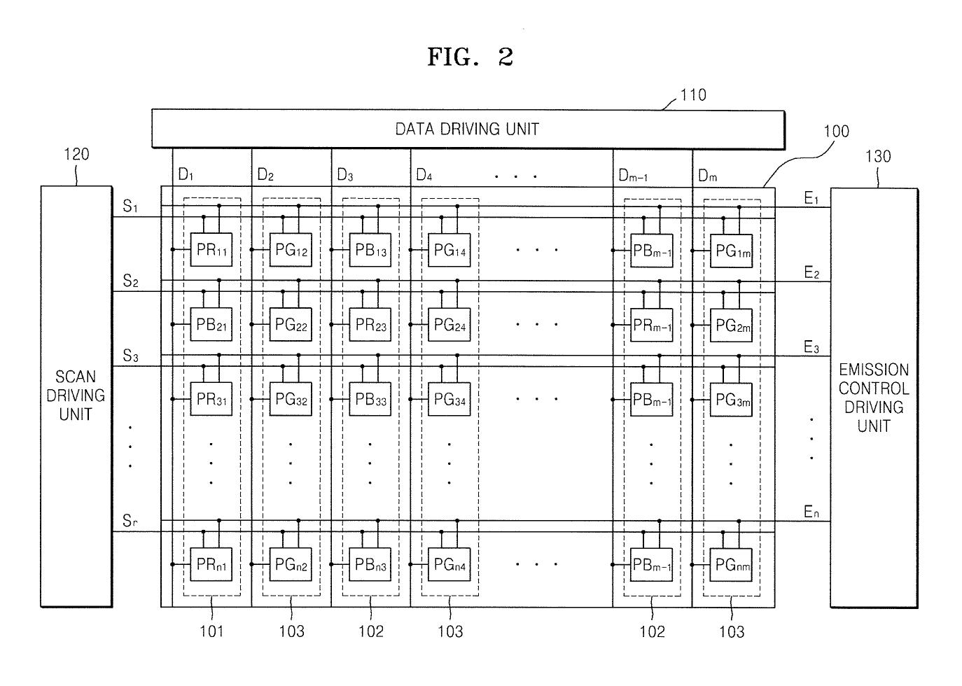

FIG. 2 is a view of the structure of an organic light emitting display according to an embodiment of the present invention.

Referring to FIG. 2, the organic light emitting display according to an embodiment of the present invention includes a data driving unit 110 for applying data signals through a plurality of data lines D1 through Dm, a scan driving unit 120 for applying scan signals through a plurality of scan lines S1 through Sn, an emission control driving unit 130 for applying emission control signals through a plurality of emission control lines E1 through En, and a pixel unit 100 including a first pixel column 101 including first pixels PR for displaying red and second pixels PB for displaying blue alternatively aligned in a direction parallel to the data lines D1 through Dm, a second pixel column 102 including the first pixels PR and the second pixels PB alternatively aligned in the direction parallel to the data lines D1 through Dm in an order opposite to the order of the first pixels PR and the second pixels PB of the first pixel column 101, and a third pixel column 103 including third pixels PG for displaying green in the direction parallel to the data lines D1 through Dm.

Although, the first pixel column 101 and the second pixel column 102 include the first pixels PR for displaying red and the second pixels PB for displaying blue alternatively aligned, the first pixel column 101 and the second pixel column 102 may also include the first pixels PR for displaying red and the third pixels PG for displaying green alternatively aligned, or the second pixels PB for displaying blue and the third pixels PG for displaying green alternatively aligned.

In addition, the pixel unit 100 includes the first pixels PR for displaying red, the second pixels PB for displaying blue, and the third pixels PG for displaying green, the pixel unit 100 may further include a pixel (not shown) for displaying a color that is not red, green, or blue, or a plurality of pixels for displaying a plurality of different colors not including red, green, or blue.

The data driving unit 110 performs a rendering process on input red, green, and blue digital image signals, generates red, green, and blue data signals synchronized with scan signals generated by the scan driving unit 120, and then applies the generated red, green, and blue data signals to the pixel unit 100 through the data lines D1 through Dm, which are electrically connected to the pixel unit 100.

Also, the data driving unit 110 generates gamma correction signals according to gamma characteristics of the organic light emitting display. The gamma correction signals will be applied to red, green, and blue data signals. This process will be described in detail later.

The scan driving unit 120 sequentially applies scan signals to the scan lines S1 through Sn which are electrically connected to the pixel unit 100 and sequentially selects pixels from among the pixels PR, PB, and PG of the first pixel column 101, the second pixel column 102, and the third pixel column 103.

The emission control signal driving unit 130 sequentially applies emission control signals to the emission control lines El through En which are electrically connected to the pixel unit 100 so as to enable the first pixels PR, the second pixels PB, and the third pixels PG to emit light.

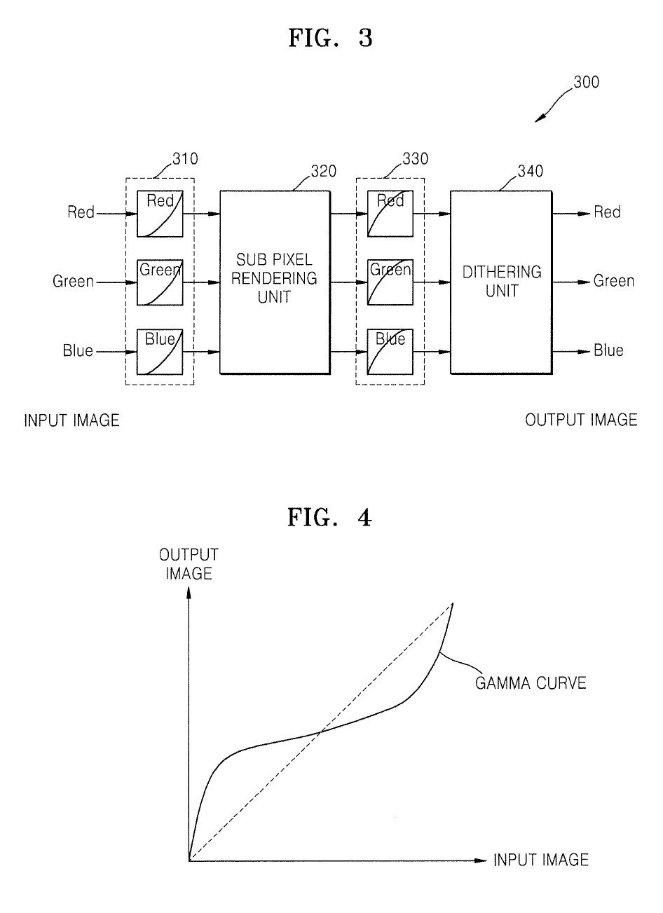

FIG. 3 is a detailed view of a gamma correction unit 300 of the data driving unit 110 of FIG. 2 for outputting gamma correction signals, according to an embodiment of the present invention.

The data driving unit 110 includes the gamma correction unit illustrated in FIG. 3 in order to generate gamma correction signals according to the gamma characteristics of the organic light emitting display and applies the generated gamma correction signals to red, green, and blue data signals.

Referring to FIG. 3, the gamma correction unit 300 includes an input correction unit 310, a sub pixel rendering unit 320, an output gamma unit 330, and a dithering unit 340.

With regard to the gamma correction unit 300 for performing gamma correction, the graph of FIG. 4 is a gamma curve representing a mathematical expression applied to the gamma correction unit 300 in order to transform a non-linear characteristic of photoelectric conversion into a linear characteristic. The gamma curve may be a curve of an output image with respect to an input image. In the gamma curve, an x-axis represents an input image and a y-axis represents an output image. Gamma correction characteristics represented by the gamma curve may be stored in a memory in advance, and when an input value is input, an output value is corrected with the gamma correction characteristics while the input value is used as an index of the memory.

The input correction unit 310 consists of three memories, and outputs an input gamma value corresponding to one first pixel PR, an input gamma value corresponding to one second pixel PB, and an input gamma value corresponding to one third pixel PG.

The sub pixel rendering unit 320 combines the input gamma values corresponding to the first pixel PR, the second pixel PB, and the third pixel PG, which are output by the input correction unit 310, with surrounding pixels so as to output an image having an alignment of one red pixel PR, one third pixel PG, one second pixel PB, and one third pixel PG.

The output gamma unit 330 is a gamma table consisting of three memories, and outputs an output gamma value corresponding to the first pixel PR, an output gamma value corresponding to the second pixel PB, and an output gamma value corresponding to the third pixel PG, each of which is output by the sub pixel rendering unit 320.

The dithering unit 340 performs a dithering process on the outputs of the output gamma unit 330 and outputs the dithered outputs to the pixel unit 100.

As illustrated in FIG. 3, the input correction unit 310 includes three memories respectively storing the input gamma values corresponding to the first pixel PR, the second pixel PB, and the third pixel PG, and the output gamma unit 330 includes three memories respectively storing the input gamma values corresponding to the first pixel PR, the second pixel PB, and the third pixel PG. The input correction unit 310 and the output gamma unit 330 account for 70% of the area of the gamma correction unit 300 and contribute to high manufacturing costs.

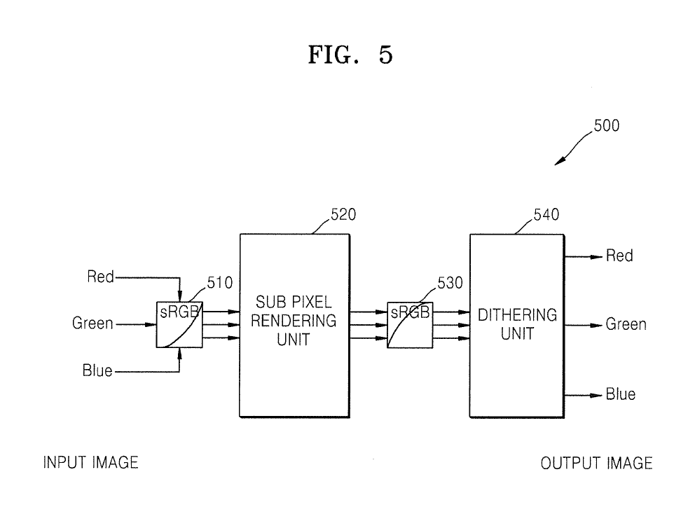

In order to reduce the area of the gamma correction unit 300 and the manufacturing costs, as illustrated in FIG. 5, the gamma correction unit 500 may include an input gamma unit 510, a sub pixel rendering unit 520, an output gamma unit 530, and a dithering unit 540.

When the gamma correction unit 500 illustrated in FIG. 5 is compared to that the gamma correction unit 300 illustrated in FIG. 3, the input gamma unit 510 includes only one memory, and outputs input gamma values respectively corresponding to one first pixel PR, one second pixel PB, and one third pixel PG of an input image.

The output gamma unit 530 includes only one memory, and outputs output gamma values respectively corresponding to the first pixel PR, the second pixel PB, and the third pixel PG, which are output by the sub pixel rendering unit 520. The process thereof is the same as described above, and thus, will not be described herein.

As illustrated in FIG. 5, when a gamma process is performed using one input gamma unit 510 and one output gamma unit 530, characteristics of a flat panel display device having different gamma characteristics of the first pixel PR, the second pixel PB, and the third pixel PG may be inappropriately expressed.

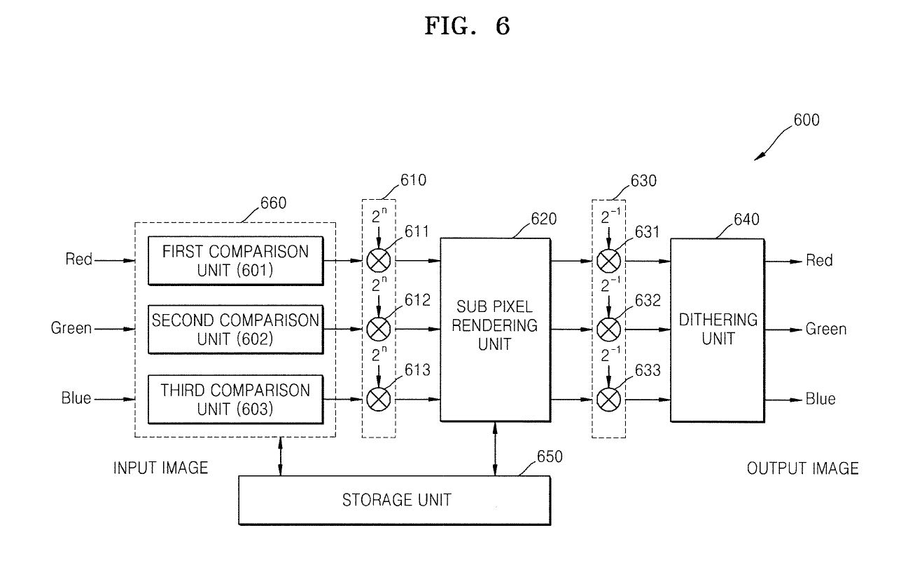

Accordingly, in order to effectively express different gamma characteristics of the first pixel PR, the second pixel PB, and the third pixel PG while reducing the area of the gamma correction unit and the manufacturing costs, a gamma correction unit 600 as illustrated in FIG. 6 may be used.

The gamma correction unit illustrated in FIG. 6 includes a comparison unit 660 including a first comparison unit 601, a second comparison unit 602, and a third comparison unit 603, a bit-number increase unit 610 including a first bit-number increase unit 611, a second bit-number increase unit 612, and a third bit-number increase unit 613, a sub pixel rendering unit 620, a bit-number decrease unit 630 including a first bit-number decrease unit 631, a second bit-number decrease unit 632 and a third bit-number decrease unit 633, a dithering unit 640, and a storage unit 650.

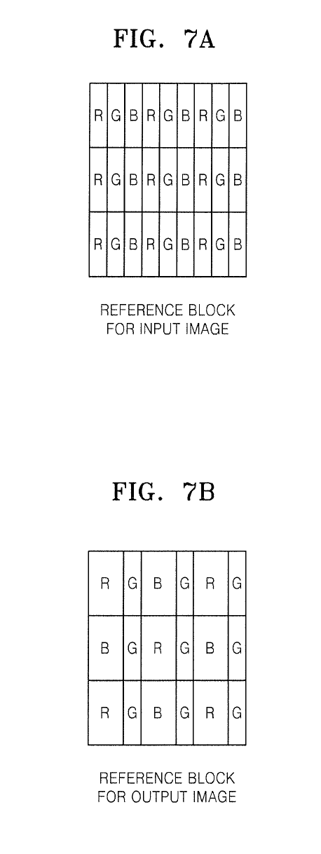

The storage unit 650 stores a reference block for an input image and a reference block for an output image. A reference block of an input or output image for compensation for an image pattern that has a large error difference with respect to a reference image pattern consists of 3×3 pixels as illustrated in FIGS. 7A and 7B. However, as illustrated in FIG. 7A, the reference block of an input image consists of 9×3 sub pixels, and as illustrated in FIG. 7B, the reference block of an output image consists of 6×3 sub pixels, due to a pentile structure. In addition, the storage unit 650 stores a compensation value of a particular pattern to be applied when a sub pixel rendering process is performed. Herein, the wording ‘compensation value of a particular pattern’ may be, for example, a weight value that is applied to one first pixel PR, one second pixel PB, and one third pixel PG of an input image so as to convert the input image which corresponds to the reference block of FIG. 7A into an output image corresponding to the reference block of 7B.

The comparison unit 660 compares the first pixel PR, the second pixel PB, and the third pixel PG of the input image with a reference block for the input image as illustrated in FIG. 7A stored in the storage unit 650. The comparison unit 660 includes the first comparison unit 601, the second comparison unit 602, and the third comparison unit 603. The first comparison unit 601 compares the first pixel PR of the input image with one first pixel PR of the reference block stored in the storage unit 650. The second comparison unit 602 compares the second pixel PB of the input image with a second pixel PB of the reference block stored in the storage unit 650. The third comparison unit 603 compares the third pixel PG of the input image with a third pixel of the reference block stored in the storage unit 650. The comparison results are used when the sub pixel rendering unit 620 operates later.

The bit-number increase unit 610 increases the number of bits of the first pixel PR, the second pixel PB, and the third pixel PG of the input image by multiplying numbers of bits of the respective pixels by 2n. In the present embodiment, the bit-number increase unit 610 includes the first bit-number increase unit 611, the second bit-number increase unit 612, and the third bit-number increase unit 613. The first bit-number increase unit 611 increases the number of bits of the input first pixel PR by multiplying the number of bits of the first pixel PR by 2n. The second bit-number increase unit 612 increases the number of bits of the input second pixel PB by multiplying the number of bits of the second pixel PB by 2n. The third bit-number increase unit 613 increases the number of bits of the input third pixel PG by multiplying the number of bits of the third pixel PG by 2n.

The sub pixel rendering unit 620 receives the first pixel PR, the second pixel PB, and the third pixel PG, each of which has a number of bits that has been increased by the bit-number increase unit 610 and outputs an image having an alignment of a first pixel PR, a third pixel PG, a second pixel PB, and a third pixel PG as illustrated in FIG. 7B, according to comparison results of the comparison unit 660. If the comparison results of the comparison unit 660 show that the first pixel PR, the second pixel PB, and the third pixel PG correspond to the reference block of the input image illustrated in FIG. 7A, the sub pixel rendering unit 620 applies a compensation weight of a particular pattern, that is, a weight value, to the first pixel PR, the second pixel PB, and the third pixel PG, which have increased a numbers of bits, so as to form the alignment of a first pixel PR, a third pixel PG, a second pixel PB, and a third pixel PG. However, if the comparison results of the comparison unit 660 show that the first pixel PR, the second pixel PB, and the third pixel PG do not correspond to the reference block of the input image illustrated in FIG. 7A, the sub pixel rendering unit 620 does not apply the compensation weight of a particular pattern to the first pixel PR, the second pixel PB, and the third pixel PG, which have increased a numbers of bits, and processes the first pixel PR, the second pixel PB, and the third pixel PG to have the alignment of a first pixel PR, a third pixel PG, a second pixel PB, and a third pixel PG and outputs an image corresponding to the pixel alignment illustrated in 7B.

The bit-number decrease unit 630 decreases the number of bits by multiplying numbers of bits of the first pixel PR, the third pixel PG, and the second pixel PB, which have been processed by the sub pixel rendering unit 620, by 2−1. The bit-number decrease unit 630 includes the first bit-number decrease unit 631, the second bit-number decrease unit 632, and the third bit-number decrease unit 633. The first bit-number decrease unit 631 decreases the number of bits of the first pixel PR output by the sub pixel rendering unit 620 by multiplying the number of bits of the first pixel PR by 2−1. The second bit-number decrease unit 632 decreases the number of bits of the second pixel PB output by the sub pixel rendering unit 620 by multiplying the number of bits of the second pixel PB by 2−1. The third bit-number decrease unit 633 decreases the number of bits of the third pixel PG output by the sub pixel rendering unit 620 by multiplying the number of bits of the third pixel PG by 2−1.

The dithering unit 640 performs a dithering process on the outputs of the bit-number decrease unit 630 and outputs the dithered outputs to the pixel unit 100.

Due to the structure described above, different gamma characteristics of the first pixel PR, the second pixel PB, and the third pixel PG may be appropriately expressed while the area of the gamma correction unit and the manufacturing costs are reduced.

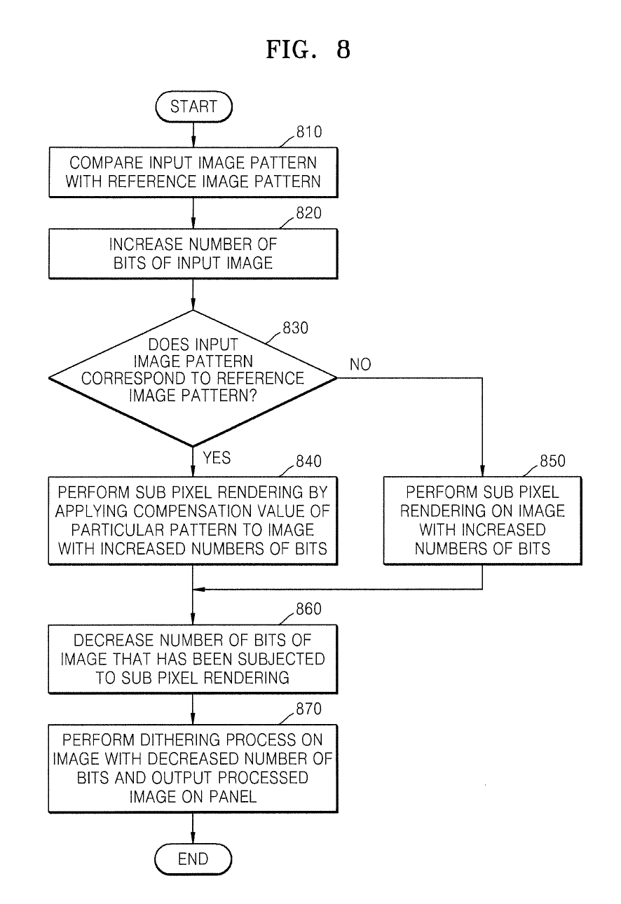

FIG. 8 is a flowchart illustrating a method of driving an organic light emitting display device according to an aspect of the present invention. The organic light emitting display is an example of a flat panel display device. The driving method of the flat panel display device according to an aspect of the present invention may be performed in the flat panel display device of FIG. 6.

When an image is input, the comparison unit 660 compares a first pixel PR, a second pixel PB, and a third pixel PG of an input image with the reference block of FIG. 7A, which has been stored in the storage unit 650 (operation 810.)

Then, the bit-number increase unit 710 increases the numbers of bits of the first pixel PR, the second pixel PB, and the third pixel PG by multiplying the numbers of bits of each pixel by 2n (operation 820.)

The sub pixel rendering unit 620 determines whether the first pixel PR, the second pixel PB, and the third pixel PG correspond to the reference block of FIG. 7A (operation 830.)

If the first pixel PR, the second pixel PB, and the third pixel PG correspond to the reference block, the sub pixel rendering unit 620 applies a compensation weight of a particular pattern, that is, a weight value, to the first pixel PR, the second pixel PB, and the third pixel PG, which have increased numbers of bits, so as to form an alignment of a first pixel PR, a third pixel PG, a second pixel PB, and a third pixel PG, and outputs an image corresponding to the pixel alignment illustrated in FIG. 7B (operation 840.)

However, if the first pixel PR, the second pixel PB, and the third pixel PG does not correspond to the reference block, the sub pixel rendering unit 620 does not apply the compensation weight of a particular pattern to the first pixel PR, the second pixel PB, and the third pixel PG, which have increased a numbers of bits, and processes the first pixel PR, the second pixel PB, and the third pixel PG to have the alignment of a first pixel PR, a third pixel PG, a second pixel PB, and a third pixel PG and outputs an image corresponding to the pixel alignment illustrated in 7B (operation 850.)

Then, the bit-number decrease unit 630 decreases the numbers of bits of the first pixel PR, the third pixel PG, and the second pixel PB by multiplying the numbers of bits of the first pixel PR, the third pixel PG, and the second pixel PB, which have been subjected to the sub-pixel rendering by 2−1 (operation 860.)

Then, the dithering unit 640 performs a dithering process on the first pixel PR, the third pixel PG, and the second pixel PB, each having the decreased number of bits and outputs the dithered pixels on a panel (operation 870.)

As described above, according to the one or more of the above embodiments of the present invention, the capacity of a memory is reduced by changing a gamma correction method, and due to the use of the small memory, the manufacturing costs are decreased.

It should be understood that the exemplary embodiments described therein should be considered in a descriptive sense only and not for purposes of limitation. Descriptions of features or aspects within each embodiment should typically be considered as available for other similar features or aspects in other embodiments.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A flat panel display device comprising:
a scan driving unit to apply scan signals through a plurality of scan lines;
a data driving unit to apply data signals through a plurality of data lines; and
a pixel unit comprising a first pixel column comprising first pixels to display a first color and second pixels to display a second color alternatively aligned in a direction parallel to the data lines, a second pixel column comprising the first pixels and the second pixels alternatively aligned in the direction parallel to the data lines in an order opposite to an order of the first pixels and the second pixels of the first pixel column, and a third pixel column comprising third pixels to display a third color in the direction parallel to the data lines,
wherein the data driving unit comprises a gamma correction unit, and when a pattern of an input image with an increased number of bits corresponds to a reference image pattern, the gamma correction unit applies a predetermined compensation value to the input image, performs a sub pixel rendering process on the compensated input image, and reduces the number of bits of the rendered image and outputs the rendered image with the decreased number of bits to the pixel unit.

2. The flat panel display device of claim 1, wherein when the pattern of the input image with an increased number of bits does not correspond to the reference image pattern, the gamma correction unit performs a sub pixel rendering process on the input image.

3. The flat panel display device of claim 2, wherein the gamma correction unit comprises:
a comparison unit to compare the pattern of the input image with the reference image pattern;
a bit-number increase unit to increase the number of bits of the input image;
a sub pixel rendering unit to apply the predetermined compensation value to the input image with the increased number of bits when the pattern of the input image corresponds to the pattern of a reference image, or to perform a sub pixel rendering on the input image with the increased number of bits when the pattern of the input image does not correspond to the pattern of the reference image; and
a bit-number decrease unit to decrease the number of bits of the image that has been subjected to the sub pixel rendering process.

4. The flat panel display device of claim 3, furthering comprising a storage unit comprising:
the reference image pattern for the input image, a reference image pattern for an output image, and the compensation value that is used when the sub pixel rendering process is performed.

5. The flat panel display device of claim 3, wherein the bit-number increase unit comprises:
a first bit-number increase unit to increase a number of bits of the first pixels of the input image;
a second bit-number increase unit to increase a number of bits of the second pixels of the input image; and
a third bit-number increase unit to increase a number of bits of the third pixels of the input image.

6. The flat panel display device of claim 3, wherein the bit-number decrease unit comprises:
a first bit-number decrease unit to decrease a number of bits of the first pixels of the image that have been subjected to the sub pixel rendering process;
a second bit-number decrease unit to decrease a number of bits of the second pixels of the image that have been subjected to the sub pixel rendering process; and
a third bit-number decrease unit to decrease a number of bits of the third pixels of the image that have been subjected to the sub pixel rendering process.

7. The flat panel display device of claim 1, further comprising an emission control driving unit to control emissions of the first pixels, the second pixels, and the third pixels.

8. The flat panel display device of claim 1, wherein the third pixels are any one of red pixels, green pixels, and blue pixels, and each of the first pixels and second pixels is different from the third pixels and any one of red pixels, green pixels, and blue pixels.

9. The flat panel display device of claim 1, wherein the third pixel column is located between the first and second pixel columns and the third color is different from the first and second colors.

10. The flat panel display device of claim 3, furthering comprising a dithering unit to perform a dithering process on an output of the bit-number decrease unit and to output the dithered outputs to the pixel unit.

11. A method of driving a flat panel display device comprising a scan driving unit to apply scan signals through a plurality of scan lines; a data driving unit to apply data signals through a plurality of data lines; and a pixel unit comprising a first pixel column comprising first pixels to display a first color and second pixels to display a second color alternatively aligned in a direction parallel to the data lines, a second pixel column comprising the first pixels and the second pixels alternatively aligned in the direction parallel to the data lines in an order opposite to the order of the first pixels and the second pixels of the first pixel column, and a third pixel column comprising third pixels to display a third color in the direction parallel to the data lines, the method comprising:
comparing a first, second, and third pixel pattern of an input image with a first, second, and third pixel reference pattern;
increasing a number of bits of the first, second, and third pixels of the first, second, and third pixel pattern of the input image;
if the input first, second, and third pixel pattern corresponds to the first, second, and third pixel reference pattern, performing a sub pixel rendering process by applying a predetermined compensation value to the first, second, and third pixels that have the increased numbers of bits; and
decreasing the numbers of bits of the first, second, and third pixels that have been subjected to the sub pixel rendering and outputting an image corresponding to the first, second, and third pixels with a decreased numbers of bits.

12. The method of claim 11, wherein
if the input first, second, and third pixel pattern does not correspond to the first, second, and third pixel reference pattern, the sub pixel rendering process is performed on the input image.

13. The method of claim 11, wherein the increasing of the numbers of bits comprises:
increasing the numbers of bits of the first pixels of the input image;
increasing the numbers of bits of the second pixels of the input image; and
increasing the numbers of bits of the third pixels of the input image.

14. The method of claim 11, wherein the decreasing of the numbers of bits comprises
decreasing the numbers of bits of the first pixels of the image that have been subjected to the sub pixel rendering;
decreasing the numbers of bits of the second pixels of the image that have been subjected to the sub pixel rendering; and
decreasing the numbers of bits of the third pixel of the image that have been subjected to the sub pixel rendering.

15. The method of claim 11, further comprising applying emission control signals to control emissions of the first pixels, the second pixels, and the third pixels.

16. The method of claim 11, wherein the third pixels are any one of red pixels, green pixels, and blue pixels, and each of the first pixels and second pixels are different from the third pixels and is any one of red pixels, green pixels, and blue pixels.
